(19) United States
(12) Patent Application Publication
(10) Pub. No.: US 2014/0314309 A1
(43) Pub. Date: Oct. 23, 2014

(54) PREPROCESSING APPARATUS IN STEREO MATCHING SYSTEM

(71) Applicant: Junseo Lee, Seoul (KR)

(72) Inventor: Junseo Lee, Seoul (KR)

(73) Assignee: LG INNOTEK CO., LTD., Seoul (KR)

(21) Appl. No.: 14/358,764

(22) PCT Filed: Jul. 3, 2012
(86) PCT No.: PCT/KR2012/005261

§ 371 Date: May 16, 2014

(30) Foreign Application Priority Data
Nov. 23, 2011 (KR) 10-2011-0123178

(51) Int. Cl. G06T 3/00

(52) U.S. Cl. CPC G06T 3/0093
USPC 382/154

(57) ABSTRACT

A preprocessing apparatus in a stereo matching system is provided. In the preprocessing apparatus, coordinate information of a stereo camera is received, a new address of a pixel of an image is specified in real time, and left and right images are interpolated, using the new address of the pixel and weight information of the stereo camera.

### TECHNICAL FIELD

The present invention relates to a technique for preprocessing a three-dimensional image, and more particularly, to a preprocessing apparatus in a stereo matching system used in a stereo camera, etc.

### BACKGROUND ART

As known well, person's sight is one of senses for obtaining peripheral environment information, and the position and distance of an object can be recognized through both eyes. That is, sight information received through both the eyes is combined as distance information, so that the person can move freely without feeling inconvenience.

A stereo camera system is used when the structure of the person's sight is implemented using a mechanism.

In the stereo camera system, stereo matching is performed on an image obtained using two cameras. In this case, external and internal structures of the two cameras are different from each other. Therefore, to equalize the internal structures of the two cameras, in a conventional stereo matching system, preprocessing is performed by creating a reference table for differences between the two cameras and applying values in the reference table to each of the two cameras.

However, since a plurality of nonvolatile memories (ROMs) should be used in the conventional stereo matching system using the reference table, the size of hardware increases, and the price of the hardware rises.

### DISCLOSURE OF INVENTION

### Technical Problem

The present invention is conceived to solve the aforementioned problems. Accordingly, an object of the present invention is to provide a preprocessing apparatus in a stereo matching system, in which weight information of a stereo camera is provided as an equal value, nonvolatile memories are removed, and the new address of the pixel is calculated in real time, so that the size and price of hardware can be decreased while maintaining the same performance.

### Solution to Problem

According to an aspect of the present invention, there is provided a preprocessing apparatus including an address generator configured to receive coordinate information of a stereo camera and specify, in real time, a new address of a pixel of an image, and an interpolator configured to interpolate left and right images, using the new address of the pixel and weight information of the stereo camera.

The coordinate information may include a left row position, a left column position, a right row position and a right column position.

The interpolator may include a left interpolator configured to interpolate the left image, and a right interpolator configured to interpolate the right image.

The address generator may specify, in real time, a new address of the pixel of the left image using the coordinate information and provide the specified new address of the pixel of the left image to the left interpolator.

The address generator may specify, in real time, a new address of the pixel of the right image using the coordinate information and provides the specified new address of the pixel of the right image to the right interpolator.

The preprocessor apparatus may further include a first storage configured to store the left and right images received from the stereo camera.

The first storage may include a volatile memory.

The weight information may be provided as a predetermined value to the interpolator.

The predetermined value may be substantially 0.25.

The interpolator may receive, in real time, new addresses of a predetermined number of pixels from the address generator, and applies the weight information to the new addresses of the predetermined number of pixels to obtain an average of the corresponding pixels.

The interpolator may further include second storages configured to store the new addresses of the predetermined number of pixels, received in real time from the address generator.

The second storage may include a volatile memory.

### Advantageous Effects of Invention

As described above, in the preprocessing apparatus in the stereo matching system according to the present invention, nonvolatile memories used in the conventional pre-processing apparatus is removed, so that it is possible to decrease the size of the system and to reduce cost.

Further, an image is rectified by equalizing weight information of a stereo camera as a predetermined value, so that the calculation of an interpolator for rectifying the image can be simplified.

Further, the expression of specifying a new address of the pixel is replaced with an equivalent expression, thereby simplifying calculation for address generation.

### BRIEF DESCRIPTION OF DRAWINGS

FIG. 1 is a configuration view illustrating a conventional preprocessing apparatus in a stereo matching system.

FIG. 2 is a configuration view illustrating a preprocessing apparatus in a stereo matching system according to an embodiment of the present invention.

FIG. 3 is an exemplary view illustrating a rectified image output by the conventional preprocessing apparatus in the stereo matching system.

FIG. 4 is an exemplary view illustrating a rectified image output by the preprocessing apparatus in the stereo matching system according to the embodiment of the present invention.

### BEST MODE FOR CARRYING OUT THE INVENTION

The present invention is described more fully hereinafter with reference to the accompanying drawings, in which embodiments of the present invention are shown. This present invention may, however, be embodied in many different forms and should not be construed as limited to the embodiments set forth herein. Rather, these embodiments are provided so that this disclosure is thorough, and will fully convey the scope of the present invention to those skilled in the art.

It will be understood that, although the terms “first,” “second,” etc. may be used herein to describe various elements, these elements should not be limited by these terms. These terms are only used to distinguish one element from another element. Thus, a “first” element discussed below could also be termed as a “second” element without departing from the teachings of the present invention.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

The terminology used herein is for the purpose of describing particular embodiments only and is not intended to be limiting of the invention. As used herein, the singular forms “a,” “an” and “the” are intended to include the plural forms as well, unless the context clearly indicates otherwise.

It will be further understood that the terms “includes” and/or “including,” when used in this specification, specify the presence of stated features, integers, steps, operations, elements, and/or components, but do not preclude the presence and/or addition of one or more other features, integers, steps, operations, elements, components, and/or groups thereof.

In the drawings, the thickness of layers, films and regions are exaggerated for clarity. Like numerals refer to like elements throughout.

Hereinafter, a conventional preprocessing apparatus will be first described, and a pre-processing apparatus according to an embodiment of the present invention will be then described in detail with reference to the accompanying drawings.

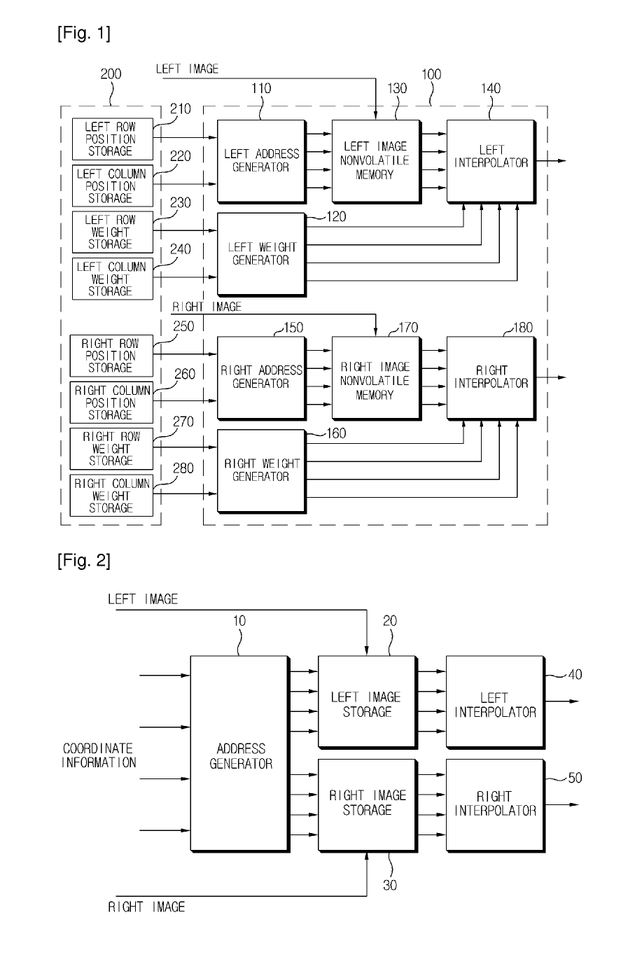

FIG. 1 is a configuration view illustrating a conventional preprocessing apparatus in a stereo matching system.

The conventional preprocessing apparatus in the stereo matching system rectifies left and right images respectively provided from two stereo cameras (not shown) using rectification parameters, and outputs the rectified left and right images by aligning epipolar lines of the left and right images.

The conventional preprocessing apparatus includes a preprocessing unit 100 and a nonvolatile memory unit 200. The nonvolatile memory unit 200 includes a left row position storage 210, a left column position storage 220, a left row weight storage 230, a left column weight storage 240, a right row position storage 250, a right column position storage 260, a right row weight storage 270 and a right column weight storage 280.

As such, the non-volatile memory unit 200 stores coordinate information including a left row position, a left column position, a right row position, a right column position, etc., and weight information including a left row weight, a left column weight, a right row weight, a right column weight, etc.

A left address generator 110 evaluates an address using data stored in the left row and column position storages 210 and 220 according to the following Math Figures. A right address generator 150 evaluates an address using data stored in the right row and column position storages 250 and 260 according to the following math figures.

MathFigure 1

x←(u−c′ₓ)/f′ₓ

y←(v−c′_{y})/f′_{y} [Math.1]

MathFigure 2

[XYW]^{T}←R⁻¹×[xy1]^{T} [Math.2]

MathFigure 3

x′←X/W

y′←Y/W [Math.3]

MathFigure 4

x″←x′(1+k₁r²+k₂r⁴+k₃r⁶)+2p₁x′y′+p₂(r²+2x′²)

y″←y′(1+k₁r²+k₂r⁴+k₃r⁶)+p₁(r²+2y′²)+2p₂x′y′ [Math.4]

MathFigure 5

mapₓ(u,v)←x″fₓ+cₓ

map_{y}(u,v)←y″f_{y}+c_{y} [Math.5]

The addresses of pixels, respectively output by the left and right address generators 110 and 150, are finally obtained through Math Figure 5.

In this case, the original camera matrix is

$$A = [ \begin{matrix}{f}_{x} & 0 & {c}_{x} \\ 0 & {f}_{y} & {c}_{y} \\ 0 & 0 & 1\end{matrix} ]$$

where

fₓ

denotes an original x-axis scale factor,

f_{y}

denotes an original y-axis scale factor,

cₓ

denotes an original x-axis principal point, and

c_{y}

denotes an original y-axis principal point.

The generated new camera matrix is

$${A}^{′} = [ \begin{matrix}{f}_{x}^{′} & 0 & {c}_{x}^{′} \\ 0 & {f}_{y}^{′} & {c}_{y}^{′} \\ 0 & 0 & 1\end{matrix} ]$$

where

f′ₓ

denotes a new x-axis scale factor,

f′_{y}

denotes a new y-axis scale factor,

c′ₓ

denotes a new x-axis principal point, and

c′_{y}

denotes a new y-axis principal point.

When assuming that the size of an image is N×M, u denotes an x-axis pixel index from 1 to N, and v denotes a y-axis pixel index from 1 to M. The left and right address generators 110 and 150 perform calculations as described above by respectively obtaining new addresses of pixels corresponding to pixels from (1, 1) to (N, M).

In this case,

k₁,

k₂,

p₁

and

p₂

denote distortion variables.

A left weight generator 120 generates a left weight using left row and column weights stored in the left row and column weight storages 230 and 240. A right weight generator 160 generates a right weight using right row and column weights stored in the right row and column weight storages 270 and 280.

Left and right interpolators 140 and 180 interpolate left and right images using the left and right addresses and the left and right weights, generated as described above, respectively.

However, since at least eight nonvolatile memories are necessarily used in the conventional preprocessing apparatus, the size of the system is increased, and a large amount of cost is required.

In order to solve the aforementioned problem of the conventional system, the present invention remove a nonvolatile memory and provides a volatile memory to an interpolator, so that it is possible to decrease the size of a system, to reduce the complexity of calculation and to save cost.

FIG. 2 is a configuration view illustrating a preprocessing apparatus in a stereo matching system according to an embodiment of the present invention.

As shown in FIG. 2, the preprocessing apparatus according to the embodiment of the present invention includes an address generator 10, a left image storage 20, a right image storage 30, a left interpolator 40 and a right interpolator 50.

The address generator 10 receives coordinate information of a stereo camera providing left and right images. The coordinate information of the stereo camera includes a left row position, a left column position, a right row position and a right column position.

The address generator 10 specifies, in real time, a new address of the pixel of the left image using the left row position and the left column position and provides the specified the new address of the pixel of the left image to the left interpolator 40. The address generator 10 specifies, in real time, a new address of the pixel of the right image using the right row position and the right column position and provides the specified the new address of the pixel of the right image to the right interpolator 50.

The address generator 10 according to the embodiment of the present invention generates the new addresses of the pixels by developing Math Figures 1 to 5 into equivalents as represented by the following Math Figures 6 to 10.

MathFigure 6

x←(u−c′ₓ)/f′ₓ

y←(v−c′_{y})/f′_{y} [Math.6]

In this case, the address generator 10 is assumed as R=I in Math Figure 2. Here, I denotes an identity matrix, and therefore,

R⁻¹=I

That is, Math Figure 2 is developed as represented by the following Math Figure 7.

MathFigure 7

[XYW]^{T}←[xy1]^{T} [Math.7]

MathFigure 8

x′←x

y′←y [Math.8]

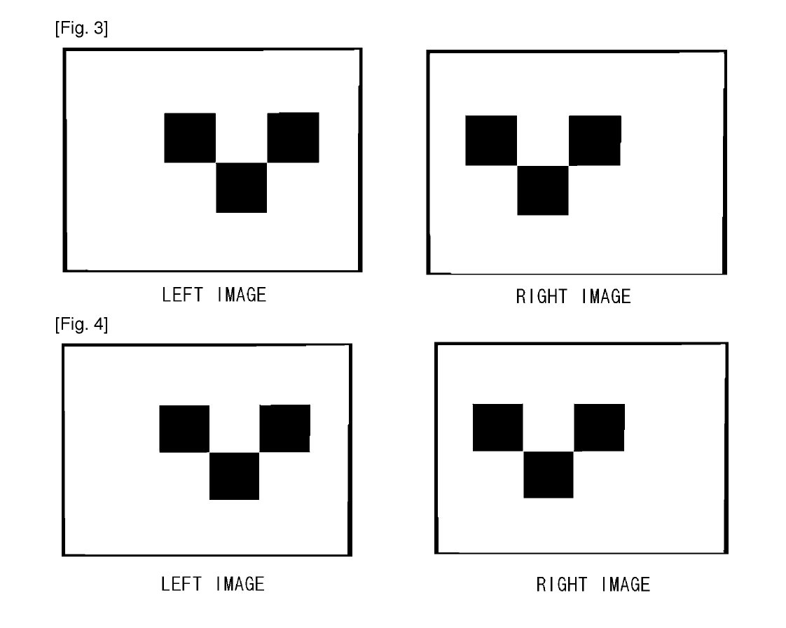

Thus, the calculation of Math Figure 8 is simplified as compared with that of Math Figure 3.

MathFigure 9

x″←x′(1+k₁r²+k₂r⁴)+2p₁x′y′+p₂(r²+2x′²)

y″←y′(1+k₁r²+k₂r⁴)+p₁(r²+2y′²)+2p₂x′y′ [Math.9]

MathFigure 10

mapₓ(u,v)←x″fₓ+cₓ

map_{y}(u,v)←y″f_{y}+c_{y} [Math.10]

The address generator 10 according to the embodiment of the present invention simplifies calculation as represented by Math Figure 9 by omitting the term

r⁶

in Math Figure 4. Since r is a very small decimal point in terms of features of the stereo camera, r is a very small value. Therefore,

r⁶

may be omitted.

Thus, it can be considered that the equivalent Math Figure described above is an optimized Math Figure, in consideration of circuit complexity, cost and performance.

The new addresses of the pixels, finally output by the address generator 10 are obtained by Math Figure 10.

In this case, the original camera matrix is

$$A = [ \begin{matrix}{f}_{x} & 0 & {c}_{x} \\ 0 & {f}_{y} & {c}_{y} \\ 0 & 0 & 1\end{matrix} ]$$

where

fₓ

denotes an original x-axis scale factor,

f_{y}

denotes an original y-axis scale factor,

cₓ

denotes an original x-axis principal point, and

c_{y}

denotes an original y-axis principal point.

The generated new camera matrix is

$${A}^{′} = [ \begin{matrix}{f}_{x}^{′} & 0 & {c}_{x}^{′} \\ 0 & {f}_{y}^{′} & {c}_{y}^{′} \\ 0 & 0 & 1\end{matrix} ]$$

where

f′ₓ

denotes a new x-axis scale factor,

f′_{y}

denotes a new y-axis scale factor,

c′ₓ

denotes a new x-axis principal point, and

c′_{y}

denotes a new y-axis principal point. In this case,

k₁,

k₂,

p₁

and

p₂

denote distortion variables.

When assuming that the size of an image is N×M, u denotes an x-axis pixel index from 1 to N, and v denotes a y-axis pixel index from 1 to M. The address generator 10 performs calculations as described above by obtaining new addresses of pixels corresponding to pixels from (1, 1) to (N, M).

The left and right image storages 20 and 30 store the respective left and right images obtained by the stereo camera (not shown), and are preferably volatile memories, but not limited thereto.

The volatile memory refers to a computer memory that requires electricity so as to maintain information stored therein, and is also called as a temporary memory. A random access memory (RAM) is used as a representative of the volatile memory.

That is, the left and right image storages 20 and 30 temporarily store the respective left and right images input from the stereo camera (not shown) and provide the stored left and right images to the respective left and right interpolators 40 and 50.

In the conventional preprocessing apparatus of FIG. 1, the weight information of the stereo cameras, i.e., the left row weight, the left column weight, the right row weight and the right column weight, respectively stored in the left row weight storage 230, the left column weight storage 240, the right row weight storage 270 and the right column weight storage 280, are provided to the left and right interpolators 140 and 180. On the other hand, in the preprocessing apparatus according to the embodiment of the present invention, predetermined values (e.g., 0.25) are provided as left and right weights to the left and right interpolators 40 and 50, respectively.

The left interpolator 40 interpolates the left image temporarily stored in the left image storage 20 using the new address of the pixel generated by the address generator 10 and the left weight input as an equal value. The right interpolator 50 interpolates the right image temporarily stored in the right image storage 30 using the new address of the pixel generated by the address generator 10 and the right weight input as an equal value.

Specifically, the left interpolator 40 receives, in real time, new addresses of four pixels, i.e., top, bottom, left and right pixels, from the address generator 10, the received new addresses of the four pixels are stored in a volatile memory unit (not shown), and weight information is applied to the stored new addresses of the pixels, thereby obtaining an average of the corresponding pixels. The right interpolator 50 receives, in real time, new addresses of four pixels, i.e., top, bottom, left and right pixels, from the address generator 10, the received new addresses of the four pixels are stored in a volatile memory unit (not shown), and weight information is applied to the stored new addresses of the pixels, thereby obtaining an average of the corresponding pixels. In the embodiment of the present invention, the same value is provided to the left and right weights.

FIG. 3 is an exemplary view illustrating a rectified image output by the conventional preprocessing apparatus in the stereo matching system. FIG. 4 is an exemplary view illustrating a rectified image output by the preprocessing apparatus in the stereo matching system according to the embodiment of the present invention. FIGS. 3 and 4 illustrate left and right images, respectively.

As shown in FIGS. 3 and 4, in the preprocessing apparatus according to the embodiment of the present invention, weight information can be equally stored by removing the nonvolatile memories that have stored the weight information, and calculations can be simplified as compared with those in the conventional preprocessing apparatus. However, it can be seen that the rectified image performed as a result by the preprocessing apparatus according to the embodiment of the present invention is almost same as that performed as a result by the conventional preprocessing apparatus.

Although the present invention has been explained by the embodiments shown in the drawings described above, it should be understood to the ordinary skilled person in the art that the present invention is not limited to the embodiments but rather that various changes or modifications thereof are possible without departing from the spirit of the present invention. Accordingly, the scope of the present invention shall be determined only by the appended claims and their equivalents.

1. A preprocessing apparatus comprising:
an address generator configured to receive coordinate information of a stereo camera and to specify, in real time, a new address of a pixel of an image; and
an interpolator configured to interpolate left and right images, using the new address of the pixel and weight information of the stereo camera.

2. The preprocessing apparatus of claim 1, wherein the coordinate information comprises a left row position, a left column position, a right row position and a right column position.

3. The preprocessing apparatus of claim 1, wherein the interpolator comprises:
a left interpolator configured to interpolate the left image; and
a right interpolator configured to interpolate the right image.

4. The preprocessing apparatus of claim 3, wherein the address generator specifies, in real time, a new address of the pixel of the left image using the coordinate information and provides the specified new address of the pixel of the left image to the left interpolator.

5. The preprocessing apparatus of claim 3, wherein the address generator specifies, in real time, a new address of the pixel of the right image using the coordinate information and provides the specified new address of the pixel of the right image to the right interpolator.

6. The preprocessing apparatus of claim 1, further comprising a first storage configured to store the left and right images received from the stereo camera.

7. The preprocessing apparatus of claim 6, wherein the first storage includes a volatile memory.

8. The preprocessing apparatus of claim 1, wherein the weight information is provided as a predetermined value to the interpolator.

9. The preprocessing apparatus of claim 8, wherein the predetermined value is substantially 0.25.

10. The preprocessing apparatus of claim 1, wherein the interpolator receives, in real time, new addresses of a predetermined number of pixels from the address generator, and applies the weight information to the new addresses of the predetermined number of pixels to obtain an average of the corresponding pixels.

11. The preprocessing apparatus of claim 10, wherein the interpolator further comprises second storages configured to store the new addresses of the predetermined number of pixels, received in real time from the address generator.

12. The preprocessing apparatus of claim 11, wherein the second storage includes a volatile memory.
